(19) United States
(12) Patent Application Publication
(10) Pub. No.: US 2024/0417570 A1
(43) Pub. Date: Dec. 19, 2024

(54) COATING COMPOSITION FOR REINFORCED PROTECTIVE LAYER

(71) Applicant: Akzo Nobel Coatings International B.V., Amsterdam (NL)

(72) Inventor: Peter Visser, Amsterdam (NL)

(21) Appl. No.: 18/725,670

(22) PCT Filed: Jan. 17, 2023
(86) PCT No.: PCT/EP2023/050986

§ 371 Date: Jun. 28, 2024

(30) Foreign Application Priority Data
Jan. 17, 2022 (EP) 22151842.6

(51) Int. Cl. C09D 5/08; C08K 3/22; C08K 3/26; C08K 3/32; C08K 5/098; C08K 5/47; C09D 5/00; C09D 7/61; C09D 7/63; C09D 175/06

(52) U.S. Cl. CPC C09D 5/086; C09D 5/002; C09D 7/61; C09D 7/63; C09D 175/06; C08K 2003/222; C08K 2003/2296; C08K 2003/262; C08K 2003/324; C08K 5/098; C08K 5/47; C08K 2201/014

(57) ABSTRACT

The disclosure relates to a coating composition comprising: a) a resin system comprising an organic film-forming resin and optionally a curing agent reactive with the organic film-forming resin, b) a lithium salt with a solubility in water in the range from 0.01 to 120 g/L at 20° C., selected from the group consisting of lithium carbonate, lithium phosphate, lithium bicarbonate, lithium tetraborate, and lithium oxalate, in an amount of at least 1.3 wt. % of lithium based on solid weight of the resin system, and c) a zinc salt of 2,5-dimercapto-1,3,4-thiadiazole (DMTD). The zinc salt of DMTD was shown to have a synergistic effect on the reinforcement of barrier properties of a protective layer that is formed in a coating defect due to the presence of the lithium salt in the coating composition.

### CROSS REFERENCE TO RELATED APPLICATION

This application is a 35 U.S.C. § 371 national phase application of PCT Application No. PCT/EP2023/050986 (published as WO/2023/135327), filed Jan. 17, 2023, which claims the benefit of priority to EP application Ser. No. 22/151,842.6, filed on Jan. 17, 2022, each of which is incorporated herein by reference in its entirety.

### FIELD OF THE TECHNOLOGY

The present disclosure relates to a coating composition with protective properties, particularly useful for metal substrates.

### BACKGROUND

Protective coatings are widely used to protect substrates, particularly metal substrates from corrosion. Hexavalent chromium compounds have long been in use as corrosion inhibitors in protective coatings and conversion coatings for metal surfaces. However, hexavalent chromium is toxic and is therefore due to be phased out for environmental, worker safety, and regulatory reasons. Alternative, chrome-free inhibitors have been proposed in the recent years however many formulations especially struggle to meet the industrial corrosion resistance standards.

While much progress is made in chrome replacement in anti-corrosive coatings, there is still a desire to provide Cr-free coatings with improved and long-term corrosion resistance properties comparable to or better than that of conventional Cr-containing coatings.

Recently, coating compositions with lithium salts have been proposed as alternative to Cr-containing coatings. See for example Visser, P., Liu, Y., Terryn, H. et al. “Lithium salts as leachable corrosion inhibitors and potential replacement for hexavalent chromium in organic coatings for the protection of aluminum alloys.” J Coat Technol Res 13, 557-566 (2016). As described in this article, coating compositions with lithium salts have demonstrated to have anti-corrosive activity due to the formation of a protective layer on bare metal at locations where the coating deposited from the coating composition with lithium salts has a defect. Such a layer was found to contain aluminum, oxygen and also lithium that leached out from the coating. The protective layer provides a barrier between the metal surface in the coating defect and the corrosive environment. This barrier function and the strength of this protective layer may be important for long-term protection. Insufficient barrier function or a lower strength of the protective layer formed can result in local metal defects and corrosion.

It is desired to provide coating compositions with improved barrier properties.

### SUMMARY

It has been found that a protective layer formed in a coating defect due to the action of a lithium salt shows a significantly higher barrier function, as observed by electrochemical impedance spectroscopy (EIS), if the coating composition also contains a zinc salt of 2,5-dimercapto-1,3,4-thiadiazole (DMTD). The zinc salt of DMTD acts as a reinforcement agent for the barrier function of the protective layer formed on the exposed metal surface.

Hence the present disclosure provides, in a first aspect, a coating composition comprising:
a) a resin system comprising an organic film-forming resin and optionally a curing agent reactive with the organic film-forming resin,
b) a lithium salt with a solubility in water in the range from 0.01 to 120 g/L at 20° C., selected from the group consisting of lithium carbonate, lithium phosphate, lithium bicarbonate, lithium tetraborate, and lithium oxalate, in an amount of at least 1.3 wt. % of lithium based on solid weight of the resin system, and
c) a zinc salt of 2,5-dimercapto-1,3,4-thiadiazole (DMTD), wherein the zinc salt of DMTD is 2,5-dimercapto-1,3,4-thiadiazole zinc salt (VII).

In a second aspect, the disclosure provides a multi-layer coating system on a metal substrate, wherein the coating system comprises a layer obtained from the coating composition according to the first aspect of the disclosure.

In a further aspect, the disclosure provides a metal substrate coated with the coating composition according to the first aspect of the disclosure.

### BRIEF DESCRIPTION OF THE DRAWINGS

FIGS. 1 and 2 show the results of EIS measurements for the coating compositions according to some embodiments of the present disclosure.

### DETAILED DESCRIPTION

It has been surprisingly found that the use of a zinc salt of DMTD in a coating composition comprising a lithium salt selected from the group consisting of lithium carbonate, lithium phosphate, lithium bicarbonate, lithium tetraborate, and lithium oxalate reinforces the protective layer formed by lithium ions of the lithium salt on a metal surface to which the coating composition is applied, in a coating defect. The formation of a protective layer by lithium ions has been previously shown to be the mechanism of the anti-corrosive working of lithium salts. When a coating defect is present in a cured coating so that the metal substrate becomes exposed and prone to corrosion, lithium ions leach out of the coating to the metal surface and contribute to the formation of a protective layer on the surface. The presence of such a protective layer can be determined and its barrier properties can be quantified using electrochemical impedance spectroscopy (EIS). See Visser, P., Liu, Y., Terryn, H. et al. “Lithium salts as leachable corrosion inhibitors and potential replacement for hexavalent chromium in organic coatings for the protection of aluminum alloys.” J Coat Technol Res 13, 557-566 (2016). This electrochemical method allows to quantify the barrier properties of the protective layer in the damaged area (scribe) generated by the active protective mechanism (leaching) of the coating after exposure to an accelerated corrosion test (e.g., neutral salt spray exposure).

The magnitude of the barrier function is derived from the electrochemical impedance spectra. The impedance modulus plots show the impedance modulus (Ω cm²) as a function of the frequency range (Hz). The increase of the impedance modulus in the middle frequency range 10 Hz can be associated with the formation of a protective layer in the damaged area (scribe). The increase of the impedance modulus at low frequencies (10 mHz) can be associated with the suppression of the corrosion processes at the substrate. An important advantage of using EIS is that it makes it possible to quantify the differences between coating formulations which cannot be observed or quantified with visual methods.

Many compounds were tested and a reinforcement agent was found that allows the protective layer formed by lithium salts to exercise a significantly higher barrier function. It is believed that such reinforced protective layer offers better and/or longer protection of the metal substrate. Higher barrier function means here higher impedance modulus values (Ω cm²) for the same frequency range (Hz) and particularly, higher impedance modulus values for the frequencies of 10 Hz and 10 mHz as measured by EIS. The reinforcement effect is synergistic, which means that the effect is much higher than expected based on individual components. Particularly, the effect is preferably at least 2 times, more preferably at least 3 times higher than the effect of individual components (in this case, of the lithium salt and the zinc salt of DMTD).

The coating composition according to the present disclosure is preferably chrome-free. “Chrome-free” means that it is free of any Cr compounds, particularly from Cr(VI) compounds such as chromates.

The coating composition according to the present disclosure comprises a) a resin system comprising an organic film-forming resin and optionally a curing agent reactive with the organic film-forming resin. Within the specification, the term “film-forming resin” includes polymers, but also monomers or oligomers, which during curing of the coating form a polymeric system. Organic film-forming resin means that the polymers, monomers or oligomers are of organic nature (carbon-containing compounds). The coating composition is preferably free of polysiloxanes. The coating composition is preferably not a sol-gel composition.

The film-forming resin can be selected from, e.g., epoxy resins, hydroxy-functional resins (like polyesters and poly(meth)acrylates), resins with one or more blocked hydroxyl groups (like acetals), oxazolidine resins, carboxylic-acid functional resins, polyacrylates, polyurethanes, polyethers, polyaspartic esters, (blocked) isocyanates, thiol-functional resins, amine-functional resins, amide-functional resins, imide-functional resins (e.g. maleimide), alkyd resins, resins containing at least one olefinically unsaturated bond, silane-containing resins, polysiloxane resins, acetoacetate resins, functional (curable) fluorinated resins, and mixtures and hybrids thereof.

Preferably, the film-forming resin is selected from the group consisting of epoxy resins and hydroxy-functional resins such as hydroxy-functional poly(meth)acrylates or polyester polyols, and polyurethanes. Epoxy resins are epoxy functional polymers with an epoxy equivalency greater than one and usually about two. Most commonly used epoxy functional polymers are polyglycidyl ethers of cyclic polyols, such as Bisphenol A, resorcinol, hydroquinone and catechol, or polyglycidyl ethers of polyols such as 1,2-cyclohexane diol, 1,4-cyclohexane diol and 1,2-bis(hydroxymethyl)cyclohexane.

Hydroxy-functional resins preferably have a hydroxy functionality between 2.1 and 3.5 and an equivalent weight of at least 200 g/mol.

Epoxy resins and polyurethanes are the preferred film-forming resins for use in the composition according to the present disclosure.

The film-forming resin is preferably present in the coating composition according to the present disclosure in an amount of 1-98.7 wt. %, more preferably 10-90 wt. %, yet more preferably 20-80 wt. %, based on the total weight of the non-volatile components of the coating composition.

The coating composition may contain a curing agent reactive with the film-forming resin. The curing agent comprises functional groups that are reactive to the functional groups of the resin. The type of the curing agent depends on the nature of the film-forming resin. Suitable curing agents for a specific film-forming resin is common knowledge for a person skilled in the art. For example, acetoacetate resin-based coating compositions preferably contain a ketimine-based curing agent.

Epoxy resin-containing compositions preferably contain an aliphatic or aromatic amine curing agent, a polyamide curing agent, or a thiol-based curing agent. Suitable epoxy resins are Bisphenol A, Bisphenol F, Bisphenol A/F, Novolac and aliphatic epoxy resins. Suitable amine curing agents are aliphatic amines and adducts thereof (e.g., Ancamine® 2021), phenalkamines, cycloaliphatic amines (e.g., Ancamine® 2196), amido amines (e.g., Ancamide® 2426), polyamides and adducts thereof, and mixtures thereof. The epoxy/NH molar ratio in epoxy-amine type coating compositions is preferably in the range 0.6 to 2.0, more preferably 0.8 to 1.7. For solvent-borne epoxy-amine coating compositions, the epoxy/NH molar ratio is preferably 0.6 to 1.4, more preferably 0.8 to 1.2, and most preferably in the range 0.85 to 1.1. For water-borne coating compositions, the epoxy/NH molar ratio is preferably 0.6 to 2.0, more preferably 0.9 to 1.7, and most preferably in the range 1.3 to 1.7.

Preferred curing agents for hydroxy-functional resins are isocyanates and isocyanurates. Suitable isocyanate curing agents are aliphatic, alicyclic, and aromatic polyisocyanates such as trimethylene diisocyanate, 1,2-propylene diisocyanate, tetramethylene diisocyanate, 2,3-butylene diisocyanate, hexamethylene diisocyanate, octamethylene diisocyanate, 2,4-trimethyl hexamethylene diisocyanate, 2,4,4-trimethyl hexamethylene diisocyanate, dodecamethylene diisocyanate, α,α′-dipropyl ether diisocyanate, 1,3-cyclopentylene diisocyanate, 1,2-cyclohexylene diisocyanate, 1,4-cyclohexylene diisocyanate, 4-methyl-1,3-cyclohexylene diisocyanate, 4,4′-dicyclohexylene diisocyanate methane, 3,3′-dimethyl-4,4′-dicyclohexylene diisocyanate methane, m- and p-phenylene diisocyanate, 1,3- and 1,4-bis(isocyanate methyl) benzene, 1,5-dimethyl-2,4-bis(isocyanate methyl)benzene, 1,3,5-triisocyanate benzene, 2,4-toluene diisocyanate, 2,6-toluene diisocyanate, 2,4,6-toluene triisocyanate, α,α,α′,α′-tetramethyl o-, m-, and p-xylylene diisocyanate, 4,4′-diphenylene diisocyanate methane, 4,4′-diphenylene diisocyanate, 3,3′-dichloro-4,4′-diphenylene diisocyanate, naphthalene-1,5-diisocyanate, isophorone diisocyanate, transvinylidene diisocyanate, and mixtures of the aforementioned polyisocyanates.

Adducts of polyisocyanates are also suitable curing agents, e.g., biurets, isocyanurates, allophonates, uretdiones, and mixtures thereof. Examples of such adducts are the adduct of two molecules of hexamethylene diisocyanate or isophorone diisocyanate to a diol such as ethylene glycol, the reaction product of 3 molecules of hexamethylene diisocyanate and 1 molecule of water, the adduct of 1 molecule of trimethylol propane to 3 molecules of isophorone diisocyanate, the adduct of 1 molecule of pentaerythritol to 4 molecules of toluene diisocyanate, the isocyanurate of hexamethylene diisocyanate (Desmodur® N3390, ex Bayer), the uretdione of hexamethylene diisocyanate (Desmodur®) N3400, ex Bayer), the allophonate of hexamethylene diisocyanate (Desmodur® LS 2101, ex Bayer), and the isocyanurate of isophorone diisocyanate (Vestanate® T1890, ex Hüls). Furthermore, (co) polymers of isocyanate-functional monomers such as α,α′-dimethyl-m-isopropenyl benzyl isocyanate are suitable for use. Finally, the above-mentioned isocyanates and adducts thereof may be present in the form of blocked or latent isocyanates.

In one preferred embodiment, the film-forming resin is a hydroxyl-functional resin and the curing agent comprises isocyanate functional groups. In another preferred embodiment, the film-forming resin comprises epoxy functional groups and the curing agent comprises amine functional groups.

The coating composition can be a one-component or two-component (2K) composition, or even a composition with more than two components. Preferably, the composition is a 2K composition. 2K coating compositions consist of two components, which are stored separately and are mixed shortly before the application to a substrate. Typically, the first component would comprise the organic film-forming resin and the second component the curing agent.

The coating composition according to the present disclosure comprises a lithium salt with a limited solubility in water.

The lithium salt has a solubility in water of at least 0.01, preferably 0.05, more preferably at least 0.1 g/L measured in water at 20° C. Lithium salts with a solubility of at least 0.5, more preferably at least 1, yet more preferably at least 5 g/L show particularly good results. Lithium salts with a solubility of below 0.01 g/L do not show enough activity. The solubility of the lithium salt is below 120 g/L, preferably below 100 g/L, more preferably below 85 g/L. A too high solubility can lead to problems in formulation of the coating composition, e.g., inhomogeneous coating composition, which can lead to problems in application. The lithium salt has a solubility in the range 0.01-120 g/L measured in water at 20° C. The solubility is preferably in the range of 1-100 g/L. Solubility in water is measured according to OECD Guideline No. 105, EU method A.6 (flask method, Procedure § 23), which describes preparation of a saturated solution, after which the concentration in the solution is measured with a suitable analytical method. A suitable analytical method for determining the concentration of relevant ions is known to the skilled person and can be chosen depending on the ion. Particularly, for lithium salts, the method of inductively coupled plasma mass spectrometry (ICP-OES) is used.

The lithium salt is selected from the group consisting of lithium carbonate, lithium phosphate, lithium bicarbonate, lithium tetraborate, and lithium oxalate. Reference herein to phosphate is to orthophosphate, unless indicated otherwise. Solubility in water of lithium carbonate is 13 g/L, lithium phosphate 0.39 g/L, lithium oxalate 62 g/L, lithium tetraborate 28 g/L, all at 20° C. Preferably, the lithium salt is selected from the group consisting of lithium carbonate, lithium phosphate, lithium oxalate, and any mixture of two or more thereof. In some embodiments, lithium carbonate is the preferred salt. It can be used alone or in mixture with other lithium salts, e.g., lithium carbonate and lithium phosphate. In other embodiments, lithium phosphate can be preferred.

It is preferred that the coating composition is free of lithium salts with a solubility lower than 0.01 g/L at 20° C. In other embodiments, it is preferred that the coating composition is free of lithium salts with a solubility in water higher than 120 g/L at 20° C., for example lithium chloride or lithium nitrate. Preferably, the coating composition is free of any lithium salts other than lithium carbonate, lithium phosphate, lithium bicarbonate, lithium tetraborate, and lithium oxalate.

The lithium salt selected from the group consisting of lithium carbonate, lithium phosphate, lithium bicarbonate, lithium tetraborate, and lithium oxalate is present in the coating composition in an amount of at least 1.3 wt. % of lithium, preferably at least 1.6 wt. %, more preferably at least 2 wt. %, even more preferably at least 2.5 wt. %, still more preferably at least 3 wt. %, based on solid weight of the resin system. “Solid weight of the resin system” refers to the total solid weight of the resin system, that is, all film-forming resins and, if present, curing agents in the coating composition. The amount of the lithium salt selected from the group consisting of lithium carbonate, lithium phosphate, lithium bicarbonate, lithium tetraborate, and lithium oxalate in the coating composition is such that the weight of lithium is preferably in range from 1.3 to 40 wt. % based on solid weight of the resin system. The coating composition preferably does not comprise more than 40 wt. %, or more than 30 wt. %, or more than 25 wt. %, or more than 20 wt. %, or more than 15 wt. %, or more than 10 wt. % of lithium based on solid weight of the resin system. Below 1.3 wt. % of lithium the reinforcement of the protective layer may be insufficient, especially when lithium carbonate is used as the lithium salt. As for the upper limit, it may be impractical to include more of lithium in the composition due to increasing costs and because the effects are already achieved at lower concentrations. If the lithium salt is lithium phosphate, the lithium phosphate is preferably present in an amount of at least 2.0 wt. % of lithium based on solid weight of the resin system, more preferably at least 3.0 wt. %, even more preferably at least 4.0 wt %, still more preferably at least 5.0 wt %.

The coating composition further comprises a zinc salt of 2,5-dimercapto-1,3,4-thiadiazole (DMTD). The zinc salt of DMTD may be present as such or as part of a hybrid compound. Reference herein to a hybrid compound (sometimes referred to as a hybrid pigment) is to an inseparable, intimate blend of two or more solid compounds comprising both organic and inorganic compounds, typically formed by co-precipitation. Examples of hybrid compounds include host-guest compounds, wherein the host matrix is inorganic and has a layered structure and the guest compound is organic. In some embodiments, however, it can be preferred that the zinc salt of DMTD does not form part of a hybrid pigment.

The zinc salt of DMTD is 2,5-dimercapto-1,3,4-thiadiazole zinc salt (VII) (CAS 63813-27-4), which is a 1:2 salt of Zn and DMTD. Description “1:2 salt” means here that it is formed from 1 mole of Zn and 2 moles of DMTD. The salt is further herein referred to as Zn(DMTD)₂ or “the zinc salt of DMTD”. The zinc salt of DMTD can be obtained by known methods, e.g., by reacting ZnO and DMTD as described in Example 1 of WO 02/092880. The zinc salt of DMTD is commercially available, e.g., as part of Inhibicor 1000 from WPC Technologies. The solubility of Zn(DMTD)₂ in water has been reported to be 0.4 g/L at 24° C.

In some embodiments, the zinc salt of DMTD is present in the coating composition in the absence of any further zinc-containing compounds, such as zinc oxide and/or zinc salts, for example zinc orthophosphate or zinc cyanamide (CH₂N₂Zn). Particularly, the coating composition is free of any of ZnO, zinc orthophosphate, zinc cyanamide or any combination of these. In some embodiments, the coating composition is free of ZnO. In some embodiments, the coating composition is free of zinc orthophosphate. In yet other embodiments, the coating composition is free of zinc cyanamide. In some embodiments, the composition is free of ZnO, zinc orthophosphate and zinc cyanamide.

Without wishing to be bound by any theory, it is believed that solely Zn(DMTD)₂ is responsible for reinforcing the barrier properties of the protective layer formed by the lithium ions in the lithium salt and therefore the presence of other Zn compounds is not necessary.

In other embodiments, however, it can be beneficial that the coating composition comprises further zinc-containing compounds, such as any of ZnO, zinc orthophosphate, zinc cyanamide or any combination of these. Examples of combinations are Zn(DMTD)₂ with ZnO, or Zn(DMTD)₂ with zinc orthophosphate, or Zn(DMTD)₂ with zinc cyanamide. If Zn(DMTD)₂ is present in combination with further zinc compounds, the amount of Zn(DMTD)₂ is from 1 to 99 wt. %, preferably from 10-98 wt. %, more preferably from 20 to 95 wt. %, most preferably from 30 to 90 wt. %, based on the total weight of zinc compounds.

In some embodiments, the content of Zn(DMTD)₂ in a mixture with other zinc compounds may be higher than 50 wt. %, preferably higher than 60 wt. %, more preferably higher than 70, most preferably higher than 80 wt. %, more preferably higher than 90 wt. % based on the solid weight of the mixture. An example of suitable mixture would be 1-30 wt. % Zn orthophosphate, 1-20 wt. % ZnO, and at least 50 wt. % Zn(DMTD)₂, such as 50-98 wt. % based on the solid weight of the mixture. Much lower content of Zn(DMTD)₂ in the Zn compounds mixture may lead to insufficient protective working, especially if the DMTD content in the coating composition is lower than 0.05 wt. % on solid weight of the resin system.

In some embodiments, Zn(DTMD)₂ is present in combination with other zinc compounds such as any of ZnO, zinc orthophosphate, zinc cyanamide or any combination of these, wherein the amount of Zn(DTMD)₂ in said mixture is higher than 50 wt. % based on the solid weight of the mixture, preferably higher than 60 wt. %, more preferably higher than 80 wt. % and most preferably higher than 90 wt. %, and wherein the DMTD content in the coating composition is at least 0.05 wt. % on solid weight of the resin system, preferably at least 1 wt. %, more preferably at least 2 wt. %.

Preferably, the zinc salt of DMTD is present in the coating composition so as to provide least 0.05 wt. % of DMTD, more preferably at least 0.1 wt. %, yet more preferably at least 0.4 wt. %, or at least 0.6 wt. %, or at least 1 wt. %, more preferably at least 2 wt. % or at least 4 wt. % of DMTD on solid weight of the resin system. Preferably, the amount is lower than 50 wt. %, or lower than 40 wt. %, or lower than 30 wt. %, or 20 wt. % DMTD on solid weight of the resin system. When used in amounts lower than 0.05 wt. % the synergistic action with lithium is believed to be too low in order to provide any benefit in practice. Using amounts higher than 50 wt. % is believed impractical, e.g., due to potential formulation issues or high cost.

The coating composition preferably contains the lithium salt and the zinc salt of DMTD in such amounts that the weight ratio of lithium to DMTD is from 0.01 to 20, preferably from 0.1 to 10, calculated as the weight ratio of lithium content to DMTD content. In some embodiments, it can be preferred that the content of DMTD (present as a zinc salt of DMTD) is equal to or higher than the content of lithium (present as a lithium salt). In other embodiments, it can be preferred that the content of DMTD (present as a zinc salt of DMTD) is equal to or lower than the content of lithium (present as a lithium salt).

As discovered and demonstrated in the examples, the combination of a lithium salt with a zinc salt of DMTD in an organic coating shows unexpected reinforcement of barrier properties of a protective layer that is formed on the exposed metal substrate. The protective layer is formed at the location where a coating defect occurs, which is simulated in the examples by scribes through the coating to expose the bare metal to the environment. Unlike other well-known corrosion inhibitors, lithium salts are known to form an irreversible protective layer on a metal substrate (e.g., aluminium alloy) through the mechanism of leaching from the coating matrix. The protective layer provides a barrier between the metal substrate and the environment. The barrier function by this layer cannot be observed visually but can be measured using electrochemical impedance spectroscopy (EIS). The presence of Zn(DMTD)₂ in a coating composition together with a lithium salt and an organic film-forming resin results in much higher impedance values for the protective layer than in cases when only a lithium salt is used, or where the lithium salt is used together with other screened potentially active compounds. Higher impedance values mean that the protective layer has a higher barrier function or is “reinforced”. A reinforced protective layer can lead to improved or longer protection. This reinforcement of the protective layer is unexpected because Zn(DMTD)₂ does not exhibit barrier properties nor form a protective layer itself, as shown by the examples below.

The coating composition can further comprise at least one magnesium compound. Suitable magnesium compounds are for example magnesium-containing materials, such as magnesium metal, magnesium oxide, oxyaminophosphate salts of magnesium (e.g., Pigmentan® 465M), magnesium carbonate, and magnesium hydroxide. Magnesium metal is suitably employed in the form of particles, for example in the form of powder, flakes, spheres or spheroids. It should be noted that magnesium metal and magnesium metal alloy particles require specific stabilizing agents when used in aqueous coating compositions. Such stabilizing agents are generally known and commercially available. Preferably, magnesium oxide is used as the magnesium compound.

The magnesium compound or compounds are preferably present in the coating composition in an amount of 0.1-50 wt. %, more preferably 1-35 wt. %, and most preferably 5-20 wt. %, based on the dry weight of the coating composition (sum of the weights of the non-volatile components of the coating composition).

Magnesium oxide or a magnesium salt is preferably present in such amount that the weight ratio of Mg:Li is at least 0.1:1, more preferably at least 0.5:1, even more preferably at least 1:1, and still more preferably at least 3:1. This ratio is preferably less than 30:1, more preferably less than 25:1, even more preferably less than 15:1, still more preferably less than 10:1, and most preferably less than 8:1.

If a magnesium metal or alloy is present in the composition according to the disclosure, the weight ratio Mg:Li is preferably less than 500:1, more preferably less than 300:1, even more preferably less than 250:1, even more preferably less than 100:1, even more preferably less than 50:1, and most preferably less than 25:1.

Preferably, the composition contains a combination of a lithium salt, as described above, magnesium oxide and the zinc salt of DMTD. These compounds are preferably present in a weight ratio of (1-5):(1-2):1, preferably around 3:1.5:1 for the lithium salt, magnesium oxide, and the zinc salt of DMTD, respectively.

In some embodiments, the coating composition further comprises one or more additional corrosion inhibitors. The additional corrosion inhibitors can be organic or inorganic. Examples of inorganic inhibitors are phosphates such as zinc orthophosphate, zinc orthophosphate hydrate, zinc aluminium orthophosphate; polyphosphates such as strontium aluminium polyphosphate hydrate, zinc aluminium polyphosphate hydrate, magnesium aluminium polyphosphate, zinc aluminium triphosphate, and magnesium aluminium triphosphate. The inhibitors further include metal oxides such as oxides of zinc, magnesium, aluminium, lithium, molybdate, strontium, cerium, and mixtures thereof; metals like metallic Zn, metallic Mg, and Mg alloys. Examples of organic inhibitors are thiol compounds and azoles like imidazoles, thiazoles, tetrazoles, triazoles like (substituted) benzotriazole, and 2-mercaptobenzothiazole.

In some embodiments, the addition corrosion inhibitor is a thiol compound or an azole, other than 2,5-dimercapto-1,3,4-thiadiazole zinc salt (VII). Azoles are 5-membered N-heterocyclic compounds containing a nitrogen atom and at least one other non-carbon atom (i.e., nitrogen, sulfur or oxygen) as part of the ring. Examples of suitable compounds include 5-methyl benzotriazole and 2-mercaptobenzothiazole (2-MBT). Preferably, 2-MBT is present as an additional corrosion inhibitor.

Other compounds that may be present in the coating composition according to the present disclosure are colour pigments (e.g. titanium dioxide or iron oxide yellow), extenders (e.g. talcum, barium sulphate, mica, calcium carbonate, silica, or wollastonite), rheology modifiers (e.g. bentone SD 2 or organic rheology modifiers), flow and levelling agents (e.g. polysiloxanes and polyacrylate levelling additives), and solvents (e.g. ketones such as methyl isobutyl ketone, aromatics such as xylene, alcohols such as benzyl alcohol, esters such as butyl acetate, and aliphatic solvents).

In a preferred embodiment, the coating composition according to the present disclosure is a liquid coating composition. The composition may comprise a volatile liquid diluent, such as a volatile organic solvent or water. The composition may be waterborne, solventborne, or solvent-free. The term “solvent-free” is defined as containing a total volatile liquid diluent content, including water and organic solvent, of less than 5 wt. %. The term “waterborne” is defined as containing at least 50 wt. % of water of the total weight of the volatile liquid diluent (including both water and organic solvents). The term “solventborne” is defined as containing organic solvent(s) in an amount of at least 50 wt. % of the total weight of volatile liquid diluent (including both water and organic solvents). Preferably, the coating composition is solventborne.

In some embodiments, the coating composition can be substantially water-free (non-aqueous), meaning that the water content is less than 1 wt. %, preferably less than 0.1 wt. %, based on the total weight of the coating composition. More preferably, the coating composition is totally free of water.

The coating composition according to the present disclosure is preferably a low temperature curable composition, which means that it is curable, i.e., can form a network, at a temperature below 120° C., preferably below 100° C., more preferably below 80° C., even more preferably below 50° C., and most preferably at ambient conditions. In other embodiments, the coating composition can be a high temperature curable composition, e.g., curable at temperatures of 120° C. and higher, preferably 140° C. and higher.

The non-volatile content of the coating composition is preferably 10-95 wt. %, more preferably 25-75 wt. %, and even more preferably 30-70 wt. %. For waterborne coating compositions, the non-volatile content is preferably in the range 30-60 wt. %.

The Volatile Organic Content (VOC) of the coating composition (determined according to ASTM D3960) is preferably less than 700 g/L, such as less than 500 g/L, more preferably less than 300 g/L.

The coating composition can be advantageously used as an anti-corrosive primer to coat non-ferrous metal substrates, such as magnesium, magnesium alloys, titanium, aluminium, aluminium alloys, and aluminium lithium alloy substrates. A preferred non-ferrous metal substrate is aluminium alloy. Examples of suitable aluminium alloys are 2024-T3 (bare or clad), 7075-T6 (bare or clad), 2098, 2099, 2198, 6061, 6111, 6022, 5052, 5083, 5251, 5454, 7475, 7017, and 7020.

The coating composition according to the present disclosure is also suitable to coat ferrous substrates. Examples of suitable ferrous substrates are cold and hot rolled steel, Stainless 304, B952 (zinc phosphate-modified), B1000 (iron phosphate-modified), and zinc-modified steel such as EZG 60G, EZG 60G with zinc phosphate modification, G90, and Galvanneal HIA Zn/Fe A45

The coating composition according to the present disclosure can be used as a primer, a bonding primer, a self-priming topcoat, an intermediate coat and/or a topcoat. It can also be used in a coating system wherein at least two layers have the composition as described in the present disclosure.

The coating composition may be applied to the substrate, with and without the use of a hexavalent chromium-free pre-treatment, such as a sol-gel system such as AC-@131 (AC Tech) or PreKote® (Pantheon Chemical), or a chemical conversion coating.

The coating composition can also be applied to anodized surfaces, such as chromic acid anodized (CAA) surfaces, tartaric sulphuric acid anodized (TSA) surfaces, sulphuric acid anodized (SAA) surfaces, phosphoric acid anodized (PAA) surfaces, phosphoric sulphuric acid anodized (PSA) surfaces and boric sulphuric acid anodized (BSAA) surfaces.

The coating composition can advantageously be used as a primer coating for non-ferrous metal substrates. It can be applied as a single layer or in multiple layers. In a preferred embodiment, the coating composition is applied to a substrate to form at least one primer layer in a multilayer coating system. A topcoat layer applied over the primer layer(s) may be a clear coat or a pigmented topcoat. Alternatively, the coating system can also comprise a colour and/or effect imparting basecoat applied on the primer layer and a clearcoat applied on top of the basecoat. The composition can also be used as a topcoat, which can be either clear or pigmented.

The present disclosure also relates to a multi-layer coating system comprising at least one layer obtained from the coating composition according to the first aspect of the disclosure, i.e., comprising resin system a), lithium salt b) and zinc salt c). After application, ingredients a), b) and c) are present within a single layer. Preferably, the layer formed from the coating composition is used as a primer layer applied to a substrate, which substrate is optionally pre-treated. The topcoat may be a clear coat or a pigmented topcoat, or when the topcoat comprises a colour and/or effect imparting base coat applied on the primer layer, a clear coat is applied on top of the base coat layer.

The present disclosure further provides a metal substrate coated with the coating composition according to the disclosure. The metal substrate may be a non-ferrous metal substrate, such as aluminium or an aluminium alloy. Alternatively, the metal substrate may be a ferrous metal substrate. The substrate may be intended for exterior or interior use. Examples include structural parts of an aircraft, parts of an aircraft cabin or a vehicle.

The coating composition is especially suitable for use in the aerospace, automotive or coil coating industry.

### Examples

### Chemicals Used

Lithium carbonate—ACS reagent, ≥99.0%, from Sigma Aldrich
Desmophen 650 MPA—branched, hydroxyl-bearing polyester from Covestro AG, 65 wt. % in 1-methoxypropylacetate-2 (MPA), 5.3% OH content
Tioxide TR92—titanium dioxide from Huntsman
Zn(DMTD)₂—prepared according to Example 1 of WO 02/092880 A1
Hybrid 1—a hybrid pigment prepared according to Example 2 of WO 02/092880 A1, containing 45 wt. % Zn(DMTD)₂, 32 wt. % Zn₃(PO₄)₂·H₂O, 23 wt. % ZnO (wt. % based on the total weight of the mixture)
Hybrid 2—a hybrid pigment prepared according to Example 1 of WO 2008/140648 A9, containing a neutralized salt of Zn(DMTD)₂ neutralized with disodium salt of DMTD (Na₂(DMTD)), estimated content 97 wt. % Zn(DMTD)₂
Hybrid 3—prepared as Hybrid 1 but containing 75 wt. % Zn(DMTD)₂, 14 wt. % Zn₃(PO₄)₂·H₂O, 11 wt. % ZnO (wt. % based on the total weight of the mixture)
Hybrid 4—prepared as Hybrid 1 but containing 15 wt. % Zn(DMTD)₂, 49 wt. % Zn₃(PO₄)₂·H₂O, 36 wt. % ZnO (wt. % based on the total weight of the mixture)
Hybrid 5—prepared as Hybrid 1 but containing 0 wt. % Zn(DMTD)₂, 58 wt. % Zn₃(PO₄)₂·H₂O, 42 wt. % ZnO (wt. % based on the total weight of the mixture) Hybrid 6-prepared as Hybrid 1 but without phosphoric acid and containing 75 wt. % Zn(DMTD)₂ and 25 wt. % ZnO (wt. % based on the total weight of the mixture)
Hybrid 7—prepared as Hybrid 1 but without phosphoric acid and containing 45 wt. % Zn(DMTD)₂ and 55 wt. % ZnO (wt. % based on the total weight of the mixture)
Hybrid 8—prepared as Hybrid 1 but without phosphoric acid and containing 15 wt. % Zn(DMTD)₂ and 85 wt. % ZnO (wt. % based on the total weight of the mixture)
Hybrid 9—prepared as Hybrid 1 but without phosphoric acid and containing 7 wt. % Zn(DMTD)₂ and 93 wt. % ZnO (wt. % based on the total weight of the mixture)
Airwhite AW 15—barium sulphate from Sibelco Specialty Minerals
Desmodur N-75 MPA/X—aliphatic polyisocyanate resin based on hexamethylene diisocyanate (HDI) and dissolved in n-butyl acetate and xylene (1:1) from Covestro AG, solids content 75 wt. %, NCO content 16.5%
Silquest A-187—epoxy-functional silane from Momentive Performance Materials

### Electrochemical Impedance Spectroscopy (EIS)

The barrier properties of the protective layer in the defect area were quantified and evaluated using electrochemical impedance spectroscopy (EIS) as described in Visser, P., Liu, Y., Terryn, H. et al. “Lithium salts as leachable corrosion inhibitors and potential replacement for hexavalent chromium in organic coatings for the protection of aluminum alloys.” J Coat Technol Res 13, 557-566 (2016).

The EIS measurements were performed at the open circuit potential (OCP) using a computer-controlled potentiostat over a frequency range from 0.01 Hz to 30000 Hz, measuring 7 points per decade and applying a sinusoidal amplitude of 10 mV. The measurements were executed using a three-electrode set-up in a Faraday cage, equipped with a saturated calomel electrode (SCE) as the reference electrode, platinum gauze as the counter electrode and the scribed panel as the working electrode using a 0.05 M NaCl electrolyte. The area exposed to the electrolyte was 12.5 cm², the effective bare electrode (i.e., the coating defect) area was 0.48 cm² and the volume of electrolyte was 60 cm³. Measurements were recorded after 2 hours exposure to the 0.05 M NaCl electrolyte on at least three samples.

The results of the examples are displayed in the form of a table with the Zmod values at 10 mHz and at 10 Hz. The higher the impedance values, the more reinforced the protective layer is.

### Preparation of Test Panels

Unless otherwise specifically described, test panels are typically 7.0 cm×7 cm (3×6-inch) and 0.8 mm thick, AA2024-T3 bare aluminum alloy, anodized in tartaric sulfuric acid (TSA) according to aerospace requirements (AIPI 02-01-003).

The coatings were applied with a high volume low pressure (HVLP) spray gun at ambient conditions (23° C., 55% RH). After the application and a 1 hour flash-off period, the coated panels were cured at 80° C. for 1 hour and left to dry under ambient conditions for 7 days. The dry film thickness of the coatings after drying was 20-25 μm. The coated panels were scribed (cross scribe 2 cm×2 cm) with a mechanical milling device leaving a U-shaped scribe of 1 mm wide and 100-150 μm deep (cross scribe 2 cm×2 cm). After scribing, the samples were exposed to the neutral salt spray test (ASTM-B117) for 168 h.

### Example 1: Synergy Between Li Salt and Zn(DTMD)₂

Formulations 1-1 to 1-4 were prepared with the ingredients listed in Table 1. The content of ingredients is indicated by weight parts (g). Also, the content of active ingredients Li and DMTD is indicated as wt. % on resin system solids.

The raw materials of Component A were added sequentially while stirring into a 370 ml glass jar. Subsequently, 400 grams Zirconox pearls (1.7-2.4 mm) were added to the mixture for grinding and dispersion of the pigments. The samples were shaken for 20 minutes on a Skandex paint shaker to achieve a fineness of grind less than 25 μm. After shaking the pearls were separated from the coating. Component B was prepared separately by mixing.

Component B was added to component A under stirring to ensure sufficient mixing to obtain homogeneous samples. The coatings were allowed to induce for 30 minutes after mixing of the separate components.

TABLE 1

| | 1-1* | 1-2* | 1-3* | 1-4 |
|---|---|---|---|---|
| Component A | | | | |
| Methyl isobutyl ketone | 60 | 60.0 | 60.0 | 60.0 |
| Desmophen 650 MPA | 47.7 | 47.7 | 47.7 | 47.7 |
| Lithium carbonate | — | — | 12.0 | 10.0 |
| Tioxide TR92 | 19.9 | 19.9 | 19.9 | 19.9 |
| Zn(DMTD)₂ | — | 6.0 | — | 6.0 |
| Airwhite AW 15 | 47.3 | 34.0 | 21.2 | 14.0 |
| Magnesium oxide | 26.6 | 19.0 | 19.0 | 19.0 |
| Component B | | | | |
| Desmodur N 75 MPA/X | 28.5 | 28.5 | 28.5 | 28.5 |
| Silquest A-187 | 5.2 | 5.2 | 5.2 | 5.2 |
| Methyl isobutyl ketone | 50.0 | 50.0 | 50.0 | 50.0 |
| Active ingredients, wt. % | | | | |
| on resin system solids | | | | |
| Li | — | — | 4.4 | 3.6 |
| DMTD | — | 9.5 | — | 9.5 |
| EIS results | | | | |
| Zmod at 10 mHz (kΩ) | 27 | 31 | 180 | 821 |
| Zmod at 10 Hz (kΩ) | 0.5 | 0.7 | 2.5 | 6 |

*comparative examples

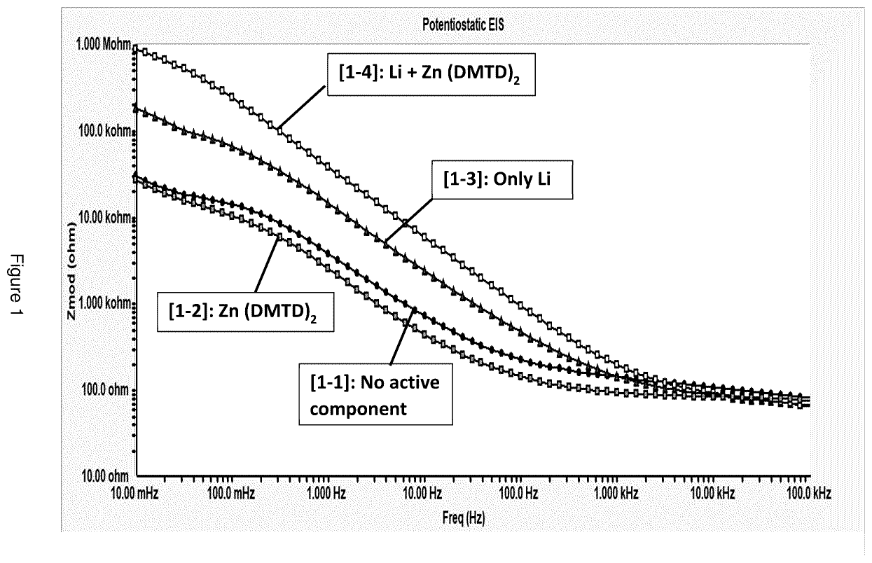

Formulations 1-1, 1-2, 1-3 are comparative formulations, while formulation 1-4 is according to the disclosure. The results of EIS measurements are shown in FIG. 1 and in Table 1.

It can be seen that the coating with both Zn(DMTD)₂ and a Li salt (1-4) shows a significantly higher impedance Z (also referred to as “Zmod”) values than the formulations without any of the active components (1-1), or with Zn(DMTD)₂ alone (1-2) or with the Li salt alone (1-3). This effect is much stronger than the sum of individual effects for a Li salt (1-3) and Zn(DMTD)₂ (1-2) and is hence a synergistic effect.

The results also show that Zn(DMTD)₂ alone (1-2) has no effect on the formation of a protective layer in the defect area. Particularly, coating 1-2 has as low impedance values as those of the coating without (Negative Reference) (1-1).

### Example 2: Comparison with Other Azoles

Formulations 2-1 to 2-7 were prepared in the same manner as in Example 1 but with the ingredients as indicated in Table 2. The content of ingredients is indicated by weight parts (g). The content of active ingredients is also indicated in wt. % on resin system solids. Molar amounts of the azoles are the same across all the formulations of this example. BTA is benzotriazole, 2-MBT is 2-mercaptobenzothiazole.

TABLE 2

| | 2-1* | 2-2* | 2-3* | 2-4* | 2-5* | 2-6* | 2-7 |
|---|---|---|---|---|---|---|---|
| Component A | | | | | | | |
| Methyl isobutyl | 60.0 | 60.0 | 60.0 | 60.0 | 60.0 | 60.0 | 60.0 |
| ketone | | | | | | | |
| Desmophen 650 | 47.7 | 47.7 | 47.7 | 47.7 | 47.7 | 47.7 | 47.7 |
| MPA | | | | | | | |
| Lithium carbonate | — | — | — | 12.0 | 10.0 | 10.0 | 10.0 |
| Tioxide TR92 | 19.9 | 19.9 | 19.9 | 19.9 | 19.9 | 19.9 | 19.9 |
| Zn(DMTD)₂ | — | — | — | — | — | — | 6.0 |
| Airwhite AW 15 | 47.3 | 35.0 | 31.0 | 21.2 | 13.5 | 9.7 | 14.0 |
| Magnesium oxide | 26.6 | 19.0 | 19.0 | 19.0 | 19.0 | 19.0 | 19.0 |
| BTA | — | 3.6 | — | — | 3.6 | — | — |
| 2-MBT | — | — | 5.0 | — | — | 5.0 | — |
| Component B | | | | | | | |
| Desmodur N 75 | 28.5 | 28.5 | 28.5 | 28.5 | 28.5 | 28.5 | 28.5 |
| MPA/X | | | | | | | |
| Silquest A-187 | 5.2 | 5.2 | 5.2 | 5.2 | 5.2 | 5.2 | 5.2 |
| Methyl isobutyl | 50.0 | 50.0 | 50.0 | 50.0 | 50.0 | 50.0 | 50.0 |
| ketone | | | | | | | |
| Active ingredients, | | | | | | | |
| wt. % on resin | | | | | | | |
| system solids | | | | | | | |
| Li | — | — | — | 4.4 | 3.6 | 3.6 | 3.6 |
| DMTD | — | — | — | — | — | — | 9.5 |
| BTA | — | 6.9 | — | — | 6.9 | — | |
| 2-MBT | — | — | 9.6 | — | — | 9.6 | — |
| EIS results | | | | | | | |
| Zmod at 10 mHz | 56 | 51 | 33 | 95 | 103 | 81 | 1030 |
| (kΩ) | | | | | | | |
| Zmod at 10 Hz | 1.2 | 0.7 | 0.9 | 2.4 | 1.9 | 2.4 | 5.6 |
| (kΩ) | | | | | | | |

*comparative examples

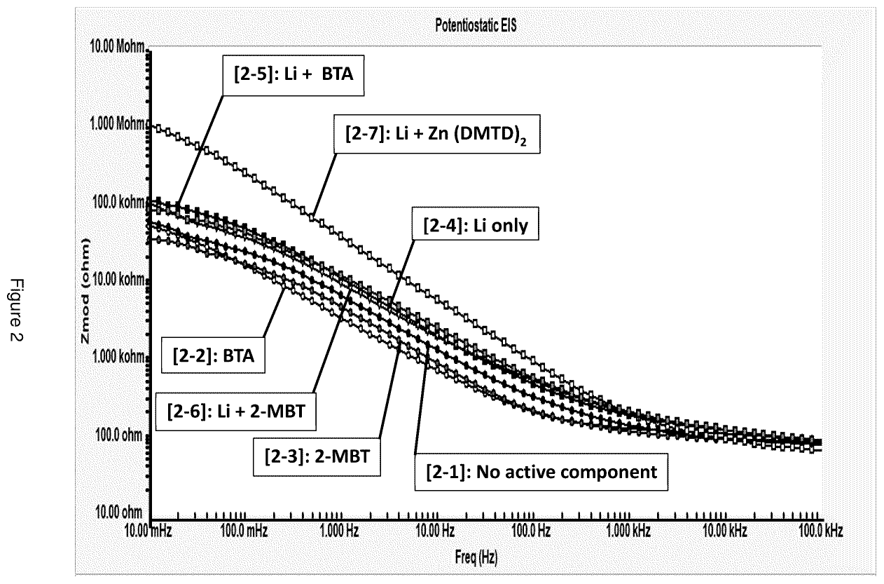

Formulations 2-1, 2-2, 2-3, 2-4, 2-5, 2-6 are comparative formulations, while formulation 2-7 is according to the disclosure. The results of EIS measurements are shown in FIG. 2 and listed in Table 2.

The results also show that combination of a Li salt with other azoles (BTA or 2-MBT) do not have the same synergistic effect as the combination with Zn(DMTD)₂. The combination of a Li salt and Zn(DMTD)₂ provides much higher impedance values related to the reinforcement of the protective layer in the defect area.

### Example 3: Zn(DMTD)₂ in Hybrid Pigments

Formulations 3-1 to 3-7 were prepared in the same manner as in Example 1 but with the ingredients as indicated in Table 3. The content of ingredients is indicated by weight parts (g). The amount of active ingredients is also given in wt. % on resin system solids.

TABLE 3

| | 3-1* | 3-2* | 3-3* | 3-4* | 3-5 | 3-6 | 3-7 |
|---|---|---|---|---|---|---|---|
| Component A | | | | | | | |
| Methyl isobutyl | 60.0 | 60.0 | 60.0 | 60.0 | 60.0 | 60.0 | 60.0 |
| ketone | | | | | | | |
| Desmophen 650 | 47.7 | 47.7 | 47.7 | 47.7 | 47.7 | 47.7 | 47.7 |
| MPA | | | | | | | |
| Lithium | — | — | — | 12.0 | 10.0 | 10.0 | 10.0 |
| Carbonate | | | | | | | |
| Tioxide TR92 | 19.9 | 19.9 | 19.9 | 19.9 | 19.9 | 19.9 | 19.9 |
| Zn(DMTD)₂ | — | — | — | — | — | — | 6.0 |
| Hybrid 1 | — | 13.3 | — | — | 13.3 | — | — |
| Hybrid 2 | — | — | 6.0 | — | — | 6.0 | — |
| Airwhite AW 15 | 47.3 | 26.5 | 34.0 | 21.2 | 4.9 | 14.0 | 14.0 |
| Magnesium oxide | 26.6 | 19.0 | 19.0 | 19.0 | 19.0 | 19.0 | 19.0 |
| Component B | | | | | | | |
| Desmodur N 75 | 28.5 | 28.5 | 28.5 | 28.5 | 28.5 | 28.5 | 28.5 |
| MPA/X | | | | | | | |
| Silquest A-187 | 5.2 | 5.2 | 5.2 | 5.2 | 5.2 | 5.2 | 5.2 |
| Methyl isobutyl | 50.0 | 50.0 | 50.0 | 50.0 | 50.0 | 50.0 | 50.0 |
| ketone | | | | | | | |
| Active ingredients, | | | | | | | |
| wt. % on resin | | | | | | | |
| system solids | | | | | | | |
| Li | — | — | — | 4.4 | 3.6 | 3.6 | 3.6 |
| DMTD | — | 9.4 | 9.4 | — | 9.5 | 9.5 | 9.5 |
| EIS results | | | | | | | |
| Zmod at 10 mHz | 27 | 27 | 28 | 165 | 816 | 865 | 875 |
| (kΩ) | | | | | | | |
| Zmod at 10 Hz | 0.7 | 0.5 | 0.7 | 2.4 | 4.6 | 4.6 | 6 |
| (kΩ) | | | | | | | |

*comparative examples

Formulations 3-1, 3-2, 3-3 and 3-4 are comparative formulations, while formulations 3-5, 3-6 and 3-7 are according to the disclosure. The results of EIS measurements are listed in Table 3.

The results show that Zn(DMTD)₂ when incorporated in a hybrid pigment shows the same effect with the lithium salt as the Zn(DMTD)₂ used as a pure component. In all formulations the total amount of Zn(DMTD)₂ in the coating is the same.

### Example 4: Different Ratio of Zn(DMTD)₂ in the Hybrid Pigment

Formulations 4-1 to 4-7 were prepared in the same manner as in Example 1 but with the ingredients as indicated in Table 4. The content of ingredients is indicated by weight parts (g). The amount of active ingredients is also given in wt. % on resin system solids.

TABLE 4

| | 4-1* | 4-2* | 4-3 | 4-4 | 4-5 | 4-6* | 4-7 |
|---|---|---|---|---|---|---|---|
| Component A | | | | | | | |
| Methyl isobutyl | 60.0 | 60.0 | 60.0 | 60.0 | 60.0 | 60.0 | 60.0 |
| ketone | | | | | | | |
| Desmophen 650 | 47.7 | 47.7 | 47.7 | 47.7 | 47.7 | 47.7 | 47.7 |
| MPA | | | | | | | |
| Lithium | — | 12.0 | 10.0 | 10.0 | 10.0 | 10.0 | 10.0 |
| Carbonate | | | | | | | |
| Tioxide TR92 | 19.9 | 19.9 | 19.9 | 19.9 | 15.5 | 19.9 | 19.9 |
| Zn(DMTD)2 | — | — | — | — | — | — | 6.0 |
| Hybrid 1 (45% | — | — | — | 13.3 | — | — | — |
| DMTD) | | | | | | | |
| Hybrid 3 (75% | — | — | 8.0 | — | — | — | — |
| DMTD) | | | | | | | |
| Hybrid 4 (15% | — | — | — | — | 31.2 | — | — |
| DMTD) | | | | | | | |
| Hybrid 5 (0% | — | — | — | — | — | 12.0 | — |
| (DMTD) | | | | | | | |
| Airwhite AW 15 | 47.3 | 21.2 | 13.0 | 4.9 | 3.9 | 13.0 | 14.0 |
| Magnesium oxide | 26.6 | 19.0 | 19.0 | 19.0 | 14.8 | 19.0 | 19.0 |
| Component B | | | | | | | |
| Desmodur N 75 | 28.5 | 28.5 | 28.5 | 28.5 | 28.5 | 28.5 | 28.5 |
| MPA/X | | | | | | | |
| Silquest A-187 | 5.2 | 5.2 | 5.2 | 5.2 | 5.2 | 5.2 | 5.2 |
| Methyl isobutyl | 50.0 | 50.0 | 50.0 | 50.0 | 50.0 | 50.0 | 50.0 |
| ketone | | | | | | | |
| Active ingredients, | | | | | | | |
| wt. % on resin | | | | | | | |
| system solids | | | | | | | |
| Lithium carbonate | — | 22.8 | 19.0 | 19.0 | 19.0 | 19.0 | 19.0 |
| Zn(DMTD)₂ | — | — | 11.5 | 11.5 | 9.0 | — | 11.5 |
| ZnO | — | — | 1.5 | 5.7 | 21.3 | 9.5 | — |
| Zn₃(PO₄)₂ | — | — | 2.1 | 8.0 | 28.9 | 13.3 | — |
| Li | — | 4.1 | 3.4 | 3.4 | 3.4 | 3.4 | 3.4 |
| DMTD | — | — | 9.4 | 9.4 | 7.2 | — | 9.4 |
| EIS results | | | | | | | |
| Zmod at 10 mHz | 47 | 154 | 525 | 500 | 389 | 129 | 896 |
| (kΩ) | | | | | | | |
| Zmod at 10 Hz | 0.5 | 3.1 | 4.9 | 3.8 | 4.9 | 3 | 4.6 |
| (kΩ) | | | | | | | |

*comparative examples

Formulations 4-1, 4-2, and 4-6 are comparative formulations, while formulations 4-3, 4-4, 4-5, and 4-7 are according to the disclosure. The results of EIS measurements are listed in Table 4.

In these examples, the weight ratio of Zn(DMTD)₂ in the hybrid pigment varied from low to high, but the amount of Zn(DMTD)₂ in the coating is the same. All the examples with hybrid pigments containing Zn(DMTD)₂ show the reinforcement effect of the protective layer in the defect area. There is nearly no difference in the reinforcement of the different hybrid pigments. Hence, the effect is not dependent on the ZnO or Zn₃(PO₄)₂ presence and their amounts.

### Example 5: Alternative Hybrid Pigments; Combination of ZnO and Zn(DMTD)₂

Formulations 5-1 to 5-7 were prepared in the same manner as in Example 1 but with the ingredients as indicated in Table 5. The content of ingredients is indicated by weight parts (g). The amount of active ingredients is also given in wt. % on resin system solids.

TABLE 5

| | 5-1* | 5-2* | 5-3 | 5-4 | 5-5 | 5-6 | 5-7 |
|---|---|---|---|---|---|---|---|
| Component A | | | | | | | |
| Methyl isobutyl | 60.0 | 60.0 | 60.0 | 60.0 | 60.0 | 60.0 | 60.0 |
| ketone | | | | | | | |
| Desmophen 650 | 47.7 | 47.7 | 47.7 | 47.7 | 47.7 | 47.7 | 47.7 |
| MPA | | | | | | | |
| Lithium Carbonate | — | 12.0 | 10.0 | 10.0 | 9.0 | 8.0 | 10.0 |
| Tioxide TR92 | 19.9 | 19.9 | 19.9 | 19.9 | 19.9 | 19.9 | 19.9 |
| Zn(DMTD)2 | — | — | — | — | — | — | 6.0 |
| Hybrid 6 (75% | — | — | 8.0 | — | — | — | — |
| DMTD) | | | | | | | |
| Hybrid 7 (45% | — | — | — | 13.3 | — | — | — |
| DMTD) | | | | | | | |
| Hybrid 8 (15% | — | — | — | — | 36.0 | — | — |
| DMTD) | | | | | | | |
| Hybrid 9 (7% | — | — | — | — | — | 64.0 | — |
| (DMTD) | | | | | | | |
| Airwhite AW 15 | 47.3 | 21.2 | 11.0 | 9.0 | — | — | 14.0 |
| Magnesium oxide | 26.6 | 19.0 | 19.0 | 19.0 | 17.1 | 15.2 | 19.0 |
| Component B | | | | | | | |
| Desmodur N 75 | 28.5 | 28.5 | 28.5 | 28.5 | 28.5 | 28.5 | 28.5 |
| MPA/X | | | | | | | |
| Silquest A-187 | 5.2 | 5.2 | 5.2 | 5.2 | 5.2 | 5.2 | 5.2 |
| Methyl isobutyl | 50.0 | 50.0 | 50.0 | 50.0 | 50.0 | 50.0 | 50.0 |
| ketone | | | | | | | |
| Active ingredients, | | | | | | | |
| wt. % on resin | | | | | | | |
| system solids | | | | | | | |
| Lithium carbonate | — | 22.8 | 19.0 | 19.0 | 19.0 | 19.0 | 19.0 |
| Zn(DMTD)₂ | — | — | 11.5 | 11.5 | 11.5 | 11.5 | 11.5 |
| ZnO | — | — | 3.8 | 14.1 | 58.2 | 112.9 | — |
| Li | — | 4.1 | 3.4 | 3.4 | 3.4 | 3.4 | 3.4 |
| DMTD | — | — | 9.4 | 9.4 | 9.4 | 9.4 | 9.4 |
| ZnO/Zn(DMTD)₂ | — | — | 25/75 | 55/45 | 85/15 | 92.5/7.5 | — |
| weight ratio | | | | | | | |
| EIS results | | | | | | | |
| Zmod at 10 mHz | 31 | 207 | 1287 | 1147 | 1125 | 1000 | 1020 |
| (kΩ) | | | | | | | |
| Zmod at 10 Hz | 0.7 | 2.5 | 5 | 5 | 5.4 | 5.9 | 4.4 |
| (kΩ) | | | | | | | |

*comparative examples

Formulations 5-1 and 5-2 are comparative formulations, while the other ones are according to the disclosure. The results of EIS measurements are listed in Table 5.

In these examples, Li salts are combined with hybrid pigments based on Zn(DMTD)₂ and only ZnO. The amount of Zn(DMTD)₂ is the same in all examples, and all samples show the same effect of reinforcement of the protective layer. It can be concluded that the presence of ZnO does not affect the synergistic effect of Li and Zn(DTMD)₂; the synergistic effect is due to the combination of a Li salt and Zn(DMTD)₂.

### Example 6: Alternative Hybrid Pigments; Combination of ZnO and Zn₃(PO₄)₂

Formulations 6-1 to 6-5 were prepared in the same manner as in Example 1 but with the ingredients as indicated in Table 6. The content of ingredients is indicated by weight parts (g). The amount of active ingredients is also given in wt. % on resin system solids.

In these experiments, performance of alternative hybrid pigments comprising ZnO and Zn₃(PO₄)₂, with and without Zn(DTMD)₂, is studied.

TABLE 6

| | 6-1* | 6-2* | 6-3* | 6-4 | 6-5 |
|---|---|---|---|---|---|
| Component A | | | | | |
| Methyl isobutyl | 60.0 | 60.0 | 60.0 | 60.0 | 60.0 |
| ketone | | | | | |
| Desmophen 650 | 47.7 | 47.7 | 47.7 | 47.7 | 47.7 |
| MPA | | | | | |
| Lithium Carbonate | — | 12.0 | 10.0 | 10.0 | 10.0 |
| Tioxide TR92 | 19.9 | 19.9 | 19.9 | 19.9 | 19.9 |
| Zn(DMTD)₂ | — | — | — | 6.0 | 6.0 |
| Hybrid 5 (42/58% | — | — | 7.3 | 7.3 | — |
| ZnO/Zn₃(PO₄)₂) | | | | | |
| Airwhite AW 15 | 47.3 | 21.2 | 17.5 | 4.9 | 14.0 |
| Magnesium oxide | 26.6 | 19.0 | 19.0 | 19.0 | 19.0 |
| Component B | | | | | |
| Desmodur N 75 | 28.5 | 28.5 | 28.5 | 28.5 | 28.5 |
| MPA/X | | | | | |
| Silquest A-187 | 5.2 | 5.2 | 5.2 | 5.2 | 5.2 |
| Methyl isobutyl | 50.0 | 50.0 | 50.0 | 50.0 | 50.0 |
| ketone | | | | | |
| Active ingredients, | | | | | |
| wt. % on resin | | | | | |
| system solids | | | | | |
| Lithium carbonate | — | 22.8 | 19.0 | 19.0 | 19.0 |
| Zn(DMTD)₂ | — | — | — | 11.5 | 11.5 |
| ZnO | — | — | 0.6 | 0.6 | — |
| Zn₃(PO₄)₂ | | | 0.8 | 0.8 | — |
| Li, % | — | 4.1 | 3.4 | 3.4 | 3.4 |
| DMTD, % | — | — | — | 9.4 | 9.4 |
| ZnO/Zn₃(PO₄)₂ | — | — | 42/58 | 42/58 | — |
| weight ratio | | | | | |
| EIS results | | | | | |
| Zmod at 10 mHz | 31 | 209 | 124 | 1071 | 1127 |
| (kΩ) | | | | | |
| Zmod at 10 Hz (kΩ) | 0.7 | 2.6 | 2.9 | 5.5 | 4.6 |

*comparative examples

Formulations 6-1, 6-2 and 6-3 are comparative formulations, while the other ones are according to the disclosure. The results of EIS measurements are listed in Table 6.

It can be concluded that the combination of hybrid pigment of ZnO and Zn₃(PO₄)₂ with the Li salt does not have a synergistic effect on the barrier effect of the protective layer. Only the presence of Zn(DMTD)₂ in this formulation provides the effect according to the disclosure.

### Example 7: Effect of ZnO

Formulations 7-1 to 7-6 were prepared in the same manner as in Example 1 but with the ingredients as indicated in Table 7. The content of ingredients is indicated by weight parts (g). The amount of active ingredients is also given in wt. % on resin system solids.

In these experiments, effect of ZnO is investigated. The examples comprise ZnO, with and without a Li salt and/or Zn(DTMD)₂. They are used in the form of a physical mixture, and not as part of a hybrid pigment.

TABLE 7

| | 7-1* | 7-2* | 7-3* | 7-4* | 7-5 | 7-6 |
|---|---|---|---|---|---|---|
| Component A | | | | | | |
| Methyl isobutyl ketone | 60.0 | 60.0 | 60.0 | 60.0 | 60.0 | 60.0 |
| Desmophen 650 MPA | 47.7 | 47.7 | 47.7 | 47.7 | 47.7 | 47.7 |
| Lithium Carbonate | — | 12.0 | — | 10.0 | 10.0 | 10.0 |
| Tioxide TR92 | 19.9 | 19.9 | 19.9 | 19.9 | 19.9 | 19.9 |
| Zn(DMTD)₂ | — | — | — | — | 6.0 | 6.0 |
| ZnO | — | — | 23.0 | 3.0 | 3.0 | — |
| Airwhite AW 15 | 47.3 | 21.2 | 27.0 | 23.0 | 10.2 | 14.0 |
| Magnesium oxide | 26.6 | 19.0 | 19.0 | 19.0 | 19.0 | 19.0 |
| Component B | | | | | | |
| Desmodur N 75 MPA/X | 28.5 | 28.5 | 28.5 | 28.5 | 28.5 | 28.5 |
| Silquest A-187 | 5.2 | 5.2 | 5.2 | 5.2 | 5.2 | 5.2 |
| Methyl isobutyl ketone | 50.0 | 50.0 | 50.0 | 50.0 | 50.0 | 50.0 |
| Active ingredients, | | | | | | |
| wt. % on resin | | | | | | |
| system solids | | | | | | |
| Lithium carbonate | — | 22.8 | — | 19.0 | 19.0 | 19.0 |
| Zn(DMTD)₂ | — | — | — | — | 11.5 | 11.5 |
| ZnO | — | — | 0.6 | 0.6 | 0.6 | — |
| Li | — | 4.1 | — | 3.4 | 3.4 | 3.4 |
| DMTD | — | — | — | — | 9.4 | 9.4 |
| EIS results | | | | | | |
| Zmod at 10 mHz (kΩ) | 35 | 205 | 36 | 102 | 1023 | 1130 |
| Zmod at 10 Hz (kΩ) | 0.8 | 2.5 | 0.7 | 2.8 | 5.3 | 4.5 |

*comparative examples

Formulations 7-1, 7-2, 7-3 and 7-4 are comparative formulations, while the other ones are according to the disclosure. The results of EIS measurements are listed in Table 7.

As can be seen from the EIS results, ZnO alone does not show any synergy with the Li salt. From this example it can be concluded that Zn(DMTD)₂ is necessary to have the reinforcement effect on the protective layer.

### Example 8: Effect of Zn₃(PO₄)₂

Formulations 8-1 to 8-6 were prepared in the same manner as in Example 1 but with the ingredients as indicated in Table 8. The content of ingredients is indicated by weight parts (g). The amount of active ingredients is also given in wt. % on resin system solids.

In these experiments, the example formulations comprise Zn₃(PO₄)₂, with and without Li and Zn(DTMD)₂. They are used in the form of a physical mixture, and not as part of a hybrid pigment.

TABLE 8

| | 8-1* | 8-2* | 8-3* | 8-4* | 8-5 | 8-6 |
|---|---|---|---|---|---|---|
| Component A | | | | | | |
| Methyl isobutyl | 60.0 | 60.0 | 60.0 | 60.0 | 60.0 | 60.0 |
| ketone | | | | | | |
| Desmophen 650 | 47.7 | 47.7 | 47.7 | 47.7 | 47.7 | 47.7 |
| MPA | | | | | | |
| Lithium | — | 12.0 | — | 10.0 | 10.0 | 10.0 |
| Carbonate | | | | | | |
| Tioxide TR92 | 19.9 | 19.9 | 19.9 | 19.9 | 19.9 | 19.9 |
| Zn(DMTD)₂ | — | — | — | — | 6.0 | 6.0 |
| Zn₃(PO₄)₂ | — | — | 20.0 | 4.3 | 4.3 | — |
| Airwhite AW 15 | 47.3 | 21.2 | 21.5 | 19.9 | 7.3 | 14.0 |
| Magnesium | 26.6 | 19.0 | 19.0 | 19.0 | 19.0 | 19.0 |
| oxide | | | | | | |
| Component B | | | | | | |
| Desmodur N 75 | 28.5 | 28.5 | 28.5 | 28.5 | 28.5 | 28.5 |
| MPA/X | | | | | | |
| Silquest A-187 | 5.2 | 5.2 | 5.2 | 5.2 | 5.2 | 5.2 |
| Methyl isobutyl | 50.0 | 50.0 | 50.0 | 50.0 | 50.0 | 50.0 |
| ketone | | | | | | |
| Active ingredients, | | | | | | |
| wt. % on resin | | | | | | |
| system solids | | | | | | |
| Lithium | — | 22.8 | — | 19.0 | 19.0 | 19.0 |
| carbonate | | | | | | |
| Zn(DMTD)₂ | — | — | — | — | 11.5 | 11.5 |
| Zn₃(PO₄)₂ | — | — | 0.8 | 0.8 | 0.8 | — |
| Li | — | 4.1 | — | 3.4 | 3.4 | 3.4 |
| DMTD | — | — | — | — | 9.4 | 9.4 |
| EIS results | | | | | | |
| Zmod at 10 mHz | 31 | 209 | 58 | 163 | 905 | 1127 |
| (kΩ) | | | | | | |
| Zmod at 10 Hz | 0.7 | 2.6 | 1.1 | 2.9 | 4.8 | 4.8 |
| (kΩ) | | | | | | |

*comparative examples

Formulations 8-1, 8-2, 8-3 and 8-4 are comparative formulations, while 8-5 and 8-6 are according to the disclosure. The results of EIS measurements are listed in Table 8.

As can be seen from the results, Zn₃(PO₄)₂ alone does not show any reinforcement effect with the Li salt in the formation of the protective layer in the defect area. The addition of Zn(DMTD)₂ to the formulation comprising a Li salt is necessary to have that synergetic reinforcement effect on the barrier properties of the protective layer.

### Example 9: Combination of ZnO with Zn₃(PO₄)₂

Formulations 9-1 to 9-6 were prepared in the same manner as in Example 1 but with the ingredients as in Table 9. The content of ingredients is indicated by weight parts (g). The amount of active ingredients is also given in wt. % on resin system solids.

In these experiments, the coating compositions comprise ZnO with Zn₃(PO₄)₂, with and without Li and Zn(DTMD)₂. The ratio of ZnO to Zn₃(PO₄)₂ is the same as in Hybrid 1 however they are used in the form of a physical mixture, and not as part of a hybrid pigment.

TABLE 9

| | 9-1* | 9-2* | 9-3* | 9-4* | 9-5 | 9-6 |
|---|---|---|---|---|---|---|
| Component A | | | | | | |
| Methyl isobutyl | 60.0 | 60.0 | 60.0 | 60.0 | 60.0 | 60.0 |
| ketone | | | | | | |
| Desmophen 650 | 47.7 | 47.7 | 47.7 | 47.7 | 47.7 | 47.7 |
| MPA | | | | | | |
| Lithium | — | 12.0 | — | 10.0 | 10.0 | 10.0 |
| Carbonate | | | | | | |
| Tioxide TR92 | 19.9 | 19.9 | 19.9 | 19.9 | 19.9 | 19.9 |
| Zn(DMTD)₂ | — | — | — | — | 6.0 | 6.0 |
| ZnO | — | — | 12.0 | 3.0 | 3.0 | |
| Zn₃(PO₄)₂ | — | — | 12.0 | 4.3 | 4.3 | — |
| Airwhite AW 15 | 47.3 | 21.2 | 21.5 | 17.5 | 4.9 | 14.0 |
| Magnesium | 26.6 | 19.0 | 19.0 | 19.0 | 19.0 | 19.0 |
| oxide | | | | | | |
| Component B | | | | | | |
| Desmodur N 75 | 28.5 | 28.5 | 28.5 | 28.5 | 28.5 | 28.5 |
| MPA/X | | | | | | |
| Silquest A-187 | 5.2 | 5.2 | 5.2 | 5.2 | 5.2 | 5.2 |
| Methyl isobutyl | 50.0 | 50.0 | 50.0 | 50.0 | 50.0 | 50.0 |
| ketone | | | | | | |
| Active ingredients, | | | | | | |
| wt. % on resin | | | | | | |
| system solids | | | | | | |
| Lithium | — | 22.8 | — | 19.0 | 19.0 | 19.0 |
| carbonate | | | | | | |
| Zn(DMTD)₂ | — | — | — | — | 11.5 | 11.5 |
| Zn₃(PO₄)₂ | — | — | 0.8 | 0.8 | 0.8 | — |
| ZnO | — | — | 0.6 | 0.6 | 0.6 | — |
| Li | — | 4.4 | — | 3.6 | 3.6 | 3.6 |
| DMTD | — | — | — | — | 9.4 | 9.4 |
| EIS results | | | | | | |
| Zmod at 10 mHz | 31 | 209 | 50 | 156 | 1028 | 1127 |
| (kΩ) | | | | | | |
| Zmod at 10 Hz | 0.7 | 2.6 | 0.7 | 2.9 | 5.6 | 4.8 |
| (kΩ) | | | | | | |

*comparative examples

Formulations 9-1, 9-2, 9-3 and 9-4 are comparative formulations, while 9-5 and 9-6 are according to the disclosure. The results of EIS measurements are listed in Table 9.

As can be seen from the results, the combination of ZnO with Zn₃(PO₄)₂ does not show any reinforcement effect with the Li salt. The addition of Zn(DMTD)₂ is necessary in order to obtain the reinforcement effect of the protective layer in the defect area.

### Example 10: Different Concentrations of Li Salt

Formulations 10-1 to 10-8 were prepared in the same manner as in Example 1 but with the ingredients as in Table 10. The content of ingredients is indicated by weight parts (g). The amount of active ingredients is also given in wt. % on resin system solids.

In these experiments, the formulation comprises a Li salt and Zn(DTMD)₂, wherein the concentration of the Li salt is varied.

TABLE 10

| | 10-1* | 10-2* | 10-3* | 10-4* | 10-5* | 10-6 | 10-7 | 10-8 |
|---|---|---|---|---|---|---|---|---|
| Component A | | | | | | | | |
| Methyl | 60.0 | 60.0 | 60.0 | 60.0 | 60.0 | 60.0 | 60.0 | 60.0 |
| isobutyl | | | | | | | | |
| ketone | | | | | | | | |
| Desmophen | 47.7 | 47.7 | 47.7 | 47.7 | 47.7 | 47.7 | 47.7 | 47.7 |
| 650 MPA | | | | | | | | |
| Lithium | — | 12.0 | — | 0.7 | 1.4 | 3.6 | 7.1 | 10.0 |
| Carbonate | | | | | | | | |
| Tioxide TR92 | 19.9 | 19.9 | 19.9 | 19.9 | 19.9 | 19.9 | 19.9 | 19.9 |
| Zn(DMTD)₂ | — | — | 6.0 | 6.0 | 6.0 | 6.0 | 6.0 | 6.0 |
| Airwhite AW | 47.3 | 21.2 | 34.0 | 33.0 | 31.5 | 27.0 | 19.0 | 14.0 |
| 15 | | | | | | | | |
| Magnesium | 26.6 | 19.0 | 19.0 | 19.0 | 19.0 | 19.0 | 19.0 | 19.0 |
| oxide | | | | | | | | |
| Component B | | | | | | | | |
| Desmodur N | 28.5 | 28.5 | 28.5 | 28.5 | 28.5 | 28.5 | 28.5 | 28.5 |
| 75 MPA/X | | | | | | | | |
| Silquest A-187 | 5.2 | 5.2 | 5.2 | 5.2 | 5.2 | 5.2 | 5.2 | 5.2 |
| Methyl | 50.0 | 50.0 | 50.0 | 50.0 | 50.0 | 50.0 | 50.0 | 50.0 |
| isobutyl | | | | | | | | |
| ketone | | | | | | | | |
| Active | | | | | | | | |
| ingredients, wt. | | | | | | | | |
| % on resin | | | | | | | | |
| system solids | | | | | | | | |
| Lithium | — | 23.0 | — | 1.4 | 2.7 | 6.8 | 13.6 | 19.0 |
| carbonate | | | | | | | | |
| Zn(DMTD)₂ | — | — | 11.5 | 11.5 | 11.5 | 11.5 | 11.5 | 11.5 |
| Li | — | 4.4 | — | 0.3 | 0.5 | 1.3 | 2.6 | 3.6 |
| DMTD | — | — | 9.4 | 9.4 | 9.4 | 9.4 | 9.4 | 9.4 |
| EIS results | | | | | | | | |
| Zmod at 10 | 39 | 110 | 30 | 47 | 77 | 355 | 390 | 410 |
| mHz (kΩ) | | | | | | | | |
| Zmod at 10 Hz | 0.6 | 2.1 | 0.4 | 0.6 | 1.04 | 2.1 | 2.5 | 2.7 |
| (kΩ) | | | | | | | | |

*comparative examples

Formulations 10-1, 10-2, 10-3, 10-4 and 10-5 are comparative formulations, while the other ones are according to the disclosure. The results of EIS measurements are listed in Table 10.

It can be seen that significantly higher impedance values are obtained for the compositions containing at least 1.3 wt. % Li on resin system solids in combination with Zn(DMTD)₂ compared to the sample with only a Li-salt.

### Example 11: Different Concentration of Zn(DMTD)₂

Formulations 11-1 to 11-8 were prepared in the same manner as in Example 1 but with the ingredients as in Table 11. The content of ingredients is indicated by weight parts (g). The amount of active ingredients is also given in wt. % on resin system solids.

In these experiments, the active material comprises a Li salt and Zn(DTMD)₂, wherein the concentration of Zn(DTMD)₂ is varied.

TABLE 11

| | 11-1* | 11-2* | 11-3* | 11-4 | 11-5 | 11-6 | 11-7 | 11-8 |
|---|---|---|---|---|---|---|---|---|
| Component A | | | | | | | | |
| Methyl isobutyl | 60.0 | 60.0 | 60.0 | 60.0 | 60.0 | 60.0 | 60.0 | 60.0 |
| ketone | | | | | | | | |
| Desmophen | 47.7 | 47.7 | 47.7 | 47.7 | 47.7 | 47.7 | 47.7 | 47.7 |
| 650 MPA | | | | | | | | |
| Lithium | — | 12.0 | — | 12.0 | 12.0 | 12.0 | 12.0 | 12.0 |
| Carbonate | | | | | | | | |
| Tioxide TR92 | 19.9 | 19.9 | 19.9 | 19.9 | 19.9 | 19.9 | 19.9 | 19.9 |
| Zn(DMTD)₂ | — | — | 6.0 | 0.4 | 0.7 | 1.4 | 2.8 | 4.2 |
| Airwhite | 47.3 | 21.2 | 34.0 | 33.0 | 31.5 | 27.0 | 19.0 | 14.0 |
| AW 15 | | | | | | | | |
| Magnesium | 26.6 | 19.0 | 19.0 | 19.0 | 19.0 | 19.0 | 19.0 | 19.0 |
| oxide | | | | | | | | |
| Component B | | | | | | | | |
| Desmodur N | 28.5 | 28.5 | 28.5 | 28.5 | 28.5 | 28.5 | 28.5 | 28.5 |
| 75 MPA/X | | | | | | | | |
| Silquest A-187 | 5.2 | 5.2 | 5.2 | 5.2 | 5.2 | 5.2 | 5.2 | 5.2 |
| Methyl isobutyl | 50.0 | 50.0 | 50.0 | 50.0 | 50.0 | 50.0 | 50.0 | 50.0 |
| ketone | | | | | | | | |
| Active | | | | | | | | |
| ingredients, wt. | | | | | | | | |
| % on resin | | | | | | | | |
| system solids | | | | | | | | |
| Lithium | — | 23 | — | 23 | 23 | 23 | 23 | 23 |
| carbonate | | | | | | | | |
| Zn(DMTD)₂ | — | — | 11.5 | 0.7 | 1.4 | 2.8 | 5.5 | 8.2 |
| Li | — | 4.4 | — | 4.4 | 4.4 | 4.4 | 4.4 | 4.4 |
| DMTD | — | — | 9.4 | 0.6 | 1.2 | 2.3 | 4.5 | 6.7 |
| EIS results | | | | | | | | |
| Zmod at 10 | 39 | 110 | 30 | 367 | 454 | 300 | 320 | 430 |
| mHz (kΩ) | | | | | | | | |
| Zmod at 10 Hz | 0.6 | 2.1 | 0.4 | 1.9 | 1.9 | 2.2 | 2.4 | 2.5 |
| (kΩ) | | | | | | | | |

*comparative examples

Formulations 11-1, 11-2 and 11-3 are comparative formulations, while the other ones are according to the disclosure. The results of EIS measurements are listed in Table 11.

It can be concluded that Zn(DTMD)₂ shows synergistic effect with the Li salt in any amount, even in very small amounts of DMTD such as 0.6 wt. %. Even at these low concentrations of DMTD, there is a clear improvement of the barrier properties of the protective layer (reinforcement effect) in the defect area.

### Example 12: Different Li Salts (4.4% Li)

Formulations 12-1 to 12-8 were prepared in the same manner as in Example 1 but with the ingredients as in Table 12. The content of ingredients is indicated by weight parts (g). The amount of the active ingredients is also given in wt. % on resin system solids.

In these experiments, the coating compositions comprise different soluble Li salts, with Li content 4.4 wt. % on resin system solids. The lithium salts have been selected on their different solubilities.

TABLE 12

| | 12-1* | 12-2* | 12-3* | 12-4* | 12-5* | 12-6 | 12-7 | 12-8 |
|---|---|---|---|---|---|---|---|---|
| Component A | | | | | | | | |
| Methyl isobutyl | 60.0 | 60.0 | 60.0 | 60.0 | 60.0 | 60.0 | 60.0 | 60.0 |
| ketone | | | | | | | | |
| Desmophen 650 | 47.7 | 47.7 | 47.7 | 47.7 | 47.7 | 47.7 | 47.7 | 47.7 |
| MPA | | | | | | | | |
| Lithium carbonate | — | — | 12.0 | — | — | 12.0 | — | — |
| Lithium phosphate | — | — | — | 12.8 | — | — | 12.8 | — |
| Lithium oxalate | — | — | — | — | 16.9 | — | — | 16.9 |
| Tioxide TR92 | 19.9 | 19.9 | 19.9 | 19.9 | 19.9 | 19.9 | 19.9 | 19.9 |
| Magnesium oxide | 19.0 | 19.0 | 19.0 | 19.0 | 19.0 | 19.0 | 19.0 | 19.0 |
| Barium sulphate | 46.8 | 33.9 | 20.5 | 24.1 | 10.9 | 7.6 | 11.2 | 0.0 |
| Zn(DMTD)₂ | | 6.0 | | | | 6.0 | 6.0 | 6.0 |
| Component B | | | | | | | | |
| Desmodur N 75 | 28.5 | 28.5 | 28.5 | 28.5 | 28.5 | 28.5 | 28.5 | 28.5 |
| MPA/X | | | | | | | | |
| Silquest A-187 | 5.2 | 5.2 | 5.2 | 5.2 | 5.2 | 5.2 | 5.2 | 5.2 |
| Methyl isobutyl | 50.0 | 50.0 | 50.0 | 50.0 | 50.0 | 50.0 | 50.0 | 50.0 |
| ketone | | | | | | | | |
| Active ingredients, | | | | | | | | |
| wt. % on resin | | | | | | | | |
| system solids | | | | | | | | |
| Lithium carbonate | — | — | 23.0 | — | — | 23.0 | — | — |
| Lithium phosphate | — | — | — | 24.6 | — | — | 24.6 | — |
| Lithium oxalate | — | — | — | — | 32.5 | — | — | 32.5 |
| Zn(DMTD)₂ | — | 11.4 | — | — | — | 11.4 | 11.4 | 11.4 |
| Li | — | — | 4.4 | 4.4 | 4.4 | 4.4 | 4.4 | 4.4 |
| DMTD | — | 9.5 | — | — | — | 9.5 | 9.5 | 9.5 |
| EIS results | | | | | | | | |
| Zmod at 10 mHz (kΩ) | 48 | 60 | 110 | 120 | 166 | 953 | 150 | 784 |
| Zmod at 10 Hz (kΩ) | 0.8 | 1.0 | 2.0 | 1.9 | 2.3 | 5.3 | 2.1 | 3.8 |

*comparative examples

Formulations 12-1 to 12-5 are comparative formulations, while the other ones are according to the disclosure. The results of EIS measurements are listed in Table 12.

It can be concluded that Zn(DTMD)₂ shows the reinforcement effect with Li salts. Moderate effect for lithium phosphate is believed to be due to its lower solubility in water.

### Example 13: Different Li Salts (1.3 wt. % Li)

Formulations 13-1 to 13-6 were prepared in the same manner as in Example 1 but with the ingredients as in Table 13. The content of ingredients is indicated by weight parts (g). The amount of active ingredients is also given in wt. % on resin system solids.

In these experiments, the coating compositions comprise different soluble Li salts, with Li content 1.3 wt. % on resin system solids.

TABLE 13

| | 13-1* | 13-2* | 13-3* | 13-4 | 13-5 | 13-6 |
|---|---|---|---|---|---|---|
| Component A | | | | | | |
| Methyl isobutyl ketone | 60.0 | 60.0 | 60.0 | 60.0 | 60.0 | 60.0 |
| Desmophen 650 MPA | 47.7 | 47.7 | 47.7 | 47.7 | 47.7 | 47.7 |
| Lithium carbonate | 3.6 | — | — | 3.6 | — | — |
| Lithium phosphate | — | 3.8 | — | — | 3.8 | — |
| Lithium oxalate | — | — | 5.0 | — | — | 5.0 |
| Tioxide TR92 | 19.9 | 19.9 | 19.9 | 19.9 | 19.9 | 19.9 |
| Magnesium oxide | 19.0 | 19.0 | 19.0 | 19.0 | 19.0 | 19.0 |
| Barium sulphate | 39.0 | 40.1 | 36.1 | 26.1 | 27.2 | 23.3 |
| Zn(DMTD)₂ | — | — | — | 6.0 | 6.0 | 6.0 |
| Component B | | | | | | |
| Desmodur N 75 MPA/X | 28.5 | 28.5 | 28.5 | 28.5 | 28.5 | 28.5 |
| Silquest A-187 | 5.2 | 5.2 | 5.2 | 5.2 | 5.2 | 5.2 |
| Methyl isobutyl ketone | 50.0 | 50.0 | 50.0 | 50.0 | 50.0 | 50.0 |
| Active ingredients, | | | | | | |
| wt. % on resin | | | | | | |
| system solids | | | | | | |
| Lithium carbonate | 7.0 | — | — | 7.0 | — | — |
| Lithium phosphate | — | 7.2 | — | — | 7.2 | — |
| Lithium oxalate | — | — | 9.6 | — | — | 9.6 |
| Zn(DMTD)₂ | — | — | — | 11.4 | 11.4 | 11.4 |
| Li | 1.3 | 1.3 | 1.3 | 1.3 | 1.3 | 1.3 |
| DMTD | — | — | — | 9.5 | 9.5 | 9.5 |
| EIS results | | | | | | |
| Zmod at 10 mHz (kΩ) | 71 | 59 | 168 | 567 | 57 | 725 |
| Zmod at 10 Hz (kΩ) | 2.0 | 0.9 | 1.6 | 3.9 | 1.0 | 3.5 |

*comparative examples

Formulations 13-1 to 13-3 are comparative formulations, while the other ones are according to the disclosure. The results of EIS measurements are listed in Table 13.

It can be concluded that Zn(DTMD)₂ shows reinforcement of the protective layer with most of the Li salts, also when used in a lower amount than in Example 12, except for lithium phosphate. For lithium phosphate better results were achieved with a higher Li content (Examples 12 and 15), which is believed to be due to its lower solubility in water.

### Example 14: Without Magnesium Oxide

Formulations 14-1 to 14-4 were prepared in the same manner as in Example 1 but with the ingredients as in Table 14. The content of ingredients is indicated by weight parts (g). The amount of active ingredients is also given in wt. % on resin system solids.

In these experiments, it is tested whether the reinforcement effect is also present in compositions without magnesium oxide.

TABLE 14

| | 14-1* | 14-2* | 14-3* | 14-4 |
|---|---|---|---|---|
| Component A | | | | |
| Methyl isobutyl ketone | 60.0 | 60.0 | 60.0 | 60.0 |
| Desmophen 650 MPA | 47.7 | 47.7 | 47.7 | 47.7 |
| Lithium carbonate | — | 12.0 | — | 12.0 |
| Tioxide TR92 | 19.9 | 19.9 | 19.9 | 19.9 |
| Barium sulphate | 70.6 | 44.4 | 57.8 | 31.5 |
| Zn(DMTD)₂ | — | — | 6.0 | 6.0 |
| Component B | | | | |
| Desmodur N 75 MPA/X | 28.5 | 28.5 | 28.5 | 28.5 |
| Silquest A-187 | 5.2 | 5.2 | 5.2 | 5.2 |
| Methyl isobutyl ketone | 50.0 | 50.0 | 50.0 | 50.0 |
| Active ingredients, wt. % | | | | |
| on resin system solids | | | | |
| Lithium carbonate | — | 23.0 | — | 19.0 |
| Zn(DMTD)₂ | — | — | 11.4 | 11.5 |
| Li | — | 4.4 | — | 3.6 |
| DMTD | — | — | 9.5 | 9.5 |
| EIS results | | | | |
| Zmod at 10 mHz (kΩ) | 40 | 94 | 57 | 459 |
| Zmod at 10 Hz (kΩ) | 0.6 | 1.9 | 0.8 | 4 |

*comparative examples

Formulations 14-1 to 14-3 are comparative formulations, while 14-4 is according to the disclosure. The results of EIS measurements are listed in Table 14.

It can be concluded that the reinforcement effect is also present in the absence of MgO and is purely attributed to the combination of a lithium salt and Zn(DMTD)₂.

### Example 15: Different Concentrations of Lithium Phosphate

Formulations 15-1 to 15-6 were prepared in the same manner as in Example 1 but with the ingredients as in Table 15. The content of ingredients is indicated by weight parts (g). The amount of active ingredients is also given in wt. % on resin system solids.

In these experiments, the concentration of lithium phosphate is varied such that the Li content on resin system solids ranges from 2.0 to 7.0 wt. %.

TABLE 15

| | 15-1* | 15-2* | 15-3* | 15-4 | 15-5 | 15-6 |
|---|---|---|---|---|---|---|
| Component A | | | | | | |
| Methyl isobutyl | 60.0 | 60.0 | 60.0 | 60.0 | 60.0 | 60.0 |
| ketone | | | | | | |
| Desmophen 650 | 47.7 | 47.7 | 47.7 | 47.7 | 47.7 | 47.7 |
| MPA | | | | | | |
| Lithium phosphate | — | — | 12.8 | 5.8 | 14.5 | 20.2 |
| Tioxide TR92 | 19.9 | 19.9 | 19.9 | 19.9 | 19.9 | 19.9 |
| Magnesium oxide | 19.0 | 19.0 | 19.0 | 19.0 | 19.0 | 19.0 |
| Barium sulphate | 47.3 | 34.0 | 26.0 | 25.0 | 10.0 | 1.0 |
| Zn(DMTD)₂ | | 6.0 | | 6.0 | 6.0 | 6.0 |
| Component B | | | | | | |
| Desmodur N 75 | 28.5 | 28.5 | 28.5 | 28.5 | 28.5 | 28.5 |
| MPA/X | | | | | | |
| Silquest A-187 | 5.2 | 5.2 | 5.2 | 5.2 | 5.2 | 5.2 |
| Methyl isobutyl | 50.0 | 50.0 | 50.0 | 50.0 | 50.0 | 50.0 |
| ketone | | | | | | |
| Active ingredients, | | | | | | |
| wt. % on resin | | | | | | |
| system solids | | | | | | |
| Lithium phosphate | — | — | 24.3 | 11.0 | 27.6 | 38.7 |
| Zn(DMTD)₂ | — | 11.4 | — | 11.4 | 11.4 | 11.4 |
| Li | — | — | 4.4 | 2.0 | 5.0 | 7.0 |
| DMTD | — | 9.5 | — | 9.5 | 9.5 | 9.5 |
| EIS results | | | | | | |
| Zmod at 10 mHz (kΩ) | 44 | 50 | 98 | 126 | 136 | 128 |
| Zmod at 10 Hz (kΩ) | 0.4 | 0.5 | 1.2 | 1.4 | 1.3 | 1.2 |

*comparative examples

Formulations 15-1 to 15-3 are comparative formulations, while the other ones are according to the disclosure. Test panels were prepared and scribed as described hereinabove. After scribing, the samples were exposed to the neutral salt spray test (ASTM-B117) for 96 hours. The results of EIS measurements are listed in Table 15.

1. A coating composition comprising:
a) a resin system comprising an organic film-forming resin and optionally a curing agent reactive with the organic film-forming resin,
b) a lithium salt with a solubility in water in the range from 0.01 to 120 g/L at 20° C., selected from the group consisting of lithium carbonate, lithium phosphate, lithium bicarbonate, lithium tetraborate, and lithium oxalate, in an amount of at least 1.3 wt. % of lithium based on solid weight of the resin system, and
c) a zinc salt of 2,5-dimercapto-1,3,4-thiadiazole (DMTD), wherein the zinc salt of DMTD is 2,5-dimercapto-1,3,4-thiadiazole zinc salt (VII).

2. The composition according to claim 1, wherein the composition is free of any zinc-containing compound other than the zinc salt of DMTD.

3. The composition according to claim 1, comprising a further zinc-containing compound selected from the group consisting of zinc oxide, zinc orthophosphate, zinc cyanamide, and any combinations thereof.

4. The composition according to claim 1, wherein the lithium salt b) is selected from the group consisting of lithium carbonate, lithium bicarbonate, lithium tetraborate, and lithium oxalate, preferably from the group consisting of lithium carbonate and lithium oxalate, more preferably is lithium carbonate.

5. The composition according to claim 1, wherein the lithium salt b) is lithium phosphate, and the lithium phosphate is present in an amount of at least 2.0 wt. % of lithium based on solid weight of the resin system.

6. The composition according to claim 1, wherein the zinc salt of DMTD is present in an amount of 0.05-20 wt. % of DMTD based on solid weight of the resin system.

7. The composition according to claim 1, wherein the film-forming resin is selected from the group consisting of epoxy resins, hydroxy-functional poly(meth)acrylates, polyester polyols, and polyurethanes.

8. The composition according to claim 1, further comprising a magnesium compound selected from the group consisting of magnesium, magnesium oxide, oxyaminophosphate salts of magnesium, magnesium carbonate, and magnesium hydroxide.

9. The composition according to claim 1, further comprising a thiol or an azole other than 2,5-dimercapto-1,3,4-thiadiazole zinc salt (VII).

10. A multi-layer coating system on a metal substrate, comprising a layer obtained from the coating composition according to claim 1.

11. The multi-layer coating system according to claim 10, wherein the layer obtained from the coating composition according to claim 1 is a primer layer on the metal substrate.

12. A metal substrate coated with the coating composition according to claim 1.
